(19) United States
(12) Patent Application Publication
(10) Pub. No.: US 2023/0217172 A1
(43) Pub. Date: Jul. 6, 2023

(54) SOUND STAGE ORIENTATION FOR ENCLOSED ENVIRONMENTS

(71) Applicant: Apple Inc., Cupertino, CA (US)

(72) Inventors: Daniel K. BOOTHE, San Francisco, CA (US); Onur I. ILKORUR, Santa Clara, CA (US); Marty E. JOHNSON, Los Gatos, CA (US); Chris WILK, Los Gatos, CA (US); Andrea Baldioceda OREAMUNO, Santa Clara, CA (US); Dan W. MAIER, Denver, CO (US)

(21) Appl. No.: 17/966,755

(22) Filed: Oct. 14, 2022

Related U.S. Application Data
(60) Provisional application No. 63/296,828, filed on Jan. 5, 2022.

(51) Int. Cl. H04R 5/04; H04R 5/02; H04R 3/12; H04R 1/02; H04S 1/00

(52) U.S. Cl. CPC H04R 5/04; H04R 5/023; H04R 3/12; H04R 1/025; H04S 1/007; H04R 2499/13

(57) ABSTRACT

Implementations of the subject technology provide for sound stage reversal for enclosed environments. For example, various occupants within an enclosed environment and listening to the same spatially-oriented audio content may be facing in various different respective directions. Speakers within the enclosed environment may be operated to generate the spatially-oriented audio content for the various occupants, with various respective sound stage orientations corresponding to the various different respective directions in which the occupants face.

### CROSS REFERENCE TO RELATED APPLICATIONS

This application claims the benefit of priority to U.S. Provisional Patent Application No. 63/296,828, entitled, “Sound Stage Orientation for Enclosed Environments”, filed on Jan. 5, 2022, the disclosure of which is hereby incorporated herein in its entirety.

### TECHNICAL FIELD

The present description relates generally to acoustic devices, including, for example, sound stage orientation for enclosed environments.

### BACKGROUND

Acoustic devices can include speakers that generate sound and microphones that detect sound. Acoustic devices are often deployed in enclosed spaces, such as conference rooms, to provide audio output to the population of occupants in the enclosed space.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a top view of an example apparatus having an enclosed space and speakers arranged for sound stage reversal within the enclosed space in accordance with implementations of the subject technology.

FIG. 4 illustrates a top view of the example apparatus of FIG. 3 generating audio output with a sound stage reversal within the enclosed space in accordance with implementations of the subject technology.

FIG. 5 illustrates a top view of an example apparatus having an enclosure and multiple sound stages having various orientations within the enclosure in accordance with implementations of the subject technology.

FIG. 6 illustrates a flow chart of example operations that may be performed for sound stage orientation in an enclosed environment in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Audio content is often provided in stereo and/or surround sound formats in which the audio content has a spatial orientation. For example, the audio content may have a spatial orientation that is synchronized with the temporal and spatial orientation of video content being displayed on a display screen. For example, in a movie theater, various speakers may be arranged and operated so that when an object in the movie (e.g., a car or a train) moves from right to left across the movie screen, the corresponding sound of the object is perceived by moviegoers to move from right to left across the theater. In order to provide a consistent experience for the moviegoers, the seats in the theater are arranged to face in substantially the same direction (i.e., toward the move screen) so that all of the seats in the theater have the same left-to-right orientation. In this way, a single sound stage can provide a consistent audio experience for all of the moviegoers in the theater.

Stereo or other spatially oriented audio can also be provided (e.g., with or without corresponding video content) in other enclosed environments in which all of the seats face in the same direction (e.g., in a vehicle in which all of the seats face in the forward direction of the vehicle). However, challenges can arise when providing spatially-oriented audio content in an enclosed environment in which the seats and/or the listeners (e.g., listeners seated in the seats) are oriented at various different orientations.

For example, in an autonomous vehicle (e.g., a fully autonomous vehicle or a semiautonomous vehicle in an autonomous driving mode) the seats of the vehicle may not need to face the front of the vehicle, and there may thus be an opportunity to (e.g., at times when the vehicle is in an autonomous driving mode) orient the seats to face each other, or to face a central interior location (e.g., to facilitate communication or interaction between occupants of the vehicle). In these configurations, spatially-oriented audio that is oriented with the same left-to-right orientation for all occupants/seats may create an undesirable and/or unpleasant or confusing audio experience for one or more of the occupants that are oriented differently from the orientation of the audio content. In one or more implementations as discussed herein, a vehicle can be provided with one or more seats face that each other, or face a central interior location. In one or more implementations, one or more of the seats can be rotatable from an orientation that faces in the same direction as other seats face (e.g., during a human operator mode or a semiautonomous driving mode) to an orientation that faces toward another seat or toward a central interior location (e.g., during an autonomous driving mode). Implementations of the subject technology described herein provide for multiple sound stages within an enclosed environment, with multiple different left-to-right orientations. In one or more implementations, an apparatus such as a vehicle may be provided with seats that face each other, and various speakers of the apparatus can be positioned and operated to provide a relative reversal of respective sound stages around the respective seats. In this way, each occupant can be provided with spatially oriented audio content in a sound stage around the occupant that is oriented in the same direction as the occupant.

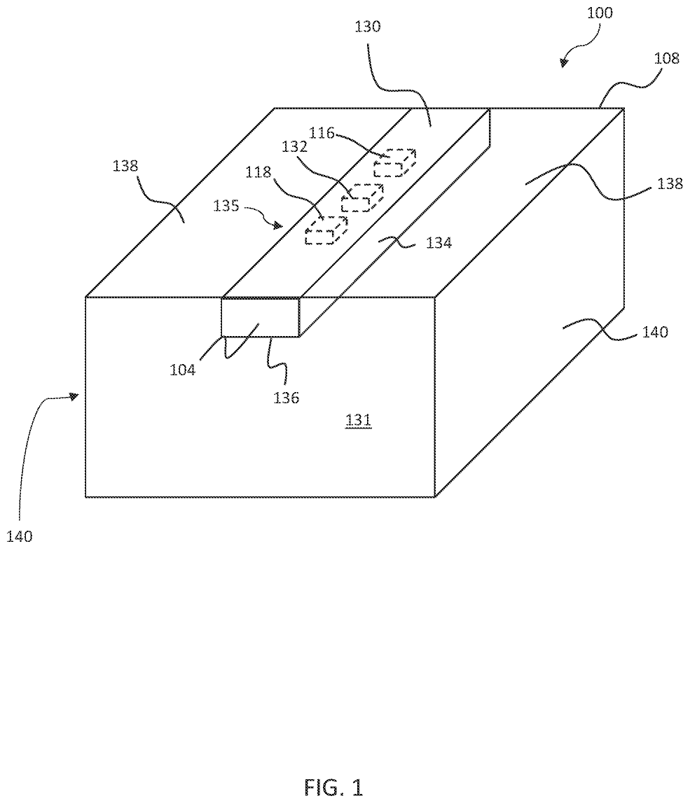

An illustrative apparatus including one or more speakers is shown in FIG. 1. In the example of FIG. 1, an apparatus 100 includes an enclosure 108 and a structural support member 104. The enclosure may (e.g., at least partially) define an enclosed environment 131. In the example of FIG. 1, the enclosure 108 includes top housing structures 138 mounted to and extending from opposing sides of the structural support member 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the structural support member 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the structural support member 104 may be formed from a curved glass structure. In this and/or other implementations, the sidewall housing structure 140 and/or other portions of the enclosure 108 may be or include a reflective surface (e.g., an acoustically reflective surface).

As illustrated in FIG. 1, the apparatus 100 may include various components such as one or more safety components 116, one or more speakers 118, and/or one or more other components 132. In the example of FIG. 1, the safety component 116, the speaker 118, and the other component 132 are mounted in a structural space 130 at least partially within the structural support member 104. The other component 132 may include, as examples, one or more displays, or more cameras, and/or one or more sensors. The cameras and/or sensors may be used to identify an occupant within the enclosed environment 131 and/or to determine the location of an occupant within the enclosed environment 131. It is also contemplated that one or more safety components 116, one or more speakers 118, and/or one or more other components 132 may also, and/or alternatively, be mounted to the enclosure 108, and/or to and/or within one or more other structures of the apparatus 100. As shown in FIG. 1, the structural support member 104 may include a first side 134, an opposing second side 135, and a bottom surface 136 that faces an interior of the enclosed environment 131 defined by the enclosure 108.

In various implementations, the apparatus 100 may be implemented as a stationary apparatus (e.g., a conference room or other room within a building) or a moveable apparatus (e.g., a train car, an airplane, a vehicle such as an autonomous or semiautonomous vehicle, a boat, a ship, a helicopter, etc.) that can be temporarily occupied by one or more human occupants and/or one or more portable electronic devices. In one or more implementations, (although not shown in FIG. 1), the apparatus 100 may include one or more seats for one or more occupants. In one or more implementations, one or more of the seats may (e.g., at least at some times) be mounted facing in the same direction as one or more other seats, and/or in a different (e.g., opposite) direction of one or more other seats.

In one or more implementations, the apparatus 100 may be implemented as a moveable platform such as a vehicle (e.g., an autonomous vehicle that navigates roadways using sensors and/or cameras and substantially without control by a human operator, a semiautonomous that includes human operator controls and that navigates roadways using sensors and/or cameras with the supervision of a human operator, or a vehicle with the capability of switching between a fully autonomous driving mode, a semiautonomous driving mode, and/or a human controlled mode).

In one or more use cases, it may be desirable to provide audio content to one or more occupants within the enclosed environment 131. The audio content may include general audio content intended for all of the occupants and/or personalized audio content for one or a subset of the occupants. The audio content may be generated by the apparatus 100, or received by the apparatus from an external source or from a portable electronic device within the enclosed environment 131. For example, in implementations in which the apparatus 100 is a moveable apparatus, it may be desirable to anchor and/or orient the perceived location and/or orientation of audio output in accordance with the location and/or content of a display or portable electronic device within the enclosed environment 131. In these and/or other use cases, it may be desirable to be able to direct the audio content, or a portion of the audio content, to one or more particular locations within the enclosed environment 131 and/or to suppress the audio content and/or a portion of the audio content at one or more other particular locations within the enclosed environment 131. In various examples, the speaker 118 may be implemented as a directional speaker (e.g., a directional speaker having sound-suppressing acoustic ducts, a dual-directional speaker, or an isobaric cross-firing speaker) or speaker of a beamforming speaker array, or any other speaker.

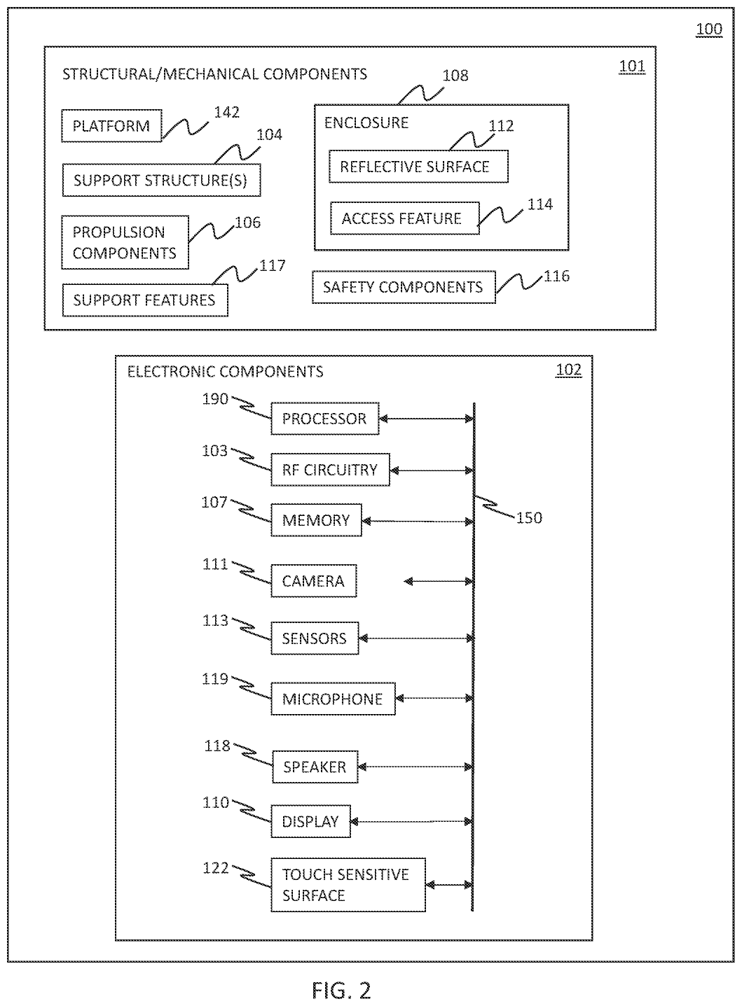

In various implementations, the apparatus 100 may include one or more other structural, mechanical, electronical, and/or computing components that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the structural support member 104, and the safety component 116 of FIG. 1. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed environment 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed environment 131 of FIG. 1.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, radar sensors, ranging sensor such as LIDAR sensors, depth sensors, temperature sensors, humidity sensors, etc. which may also be implemented in the other components 132 of FIG. 1), a microphone 119, a speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, cameras 111 and/or sensors 113 may be used to identify an occupant within the enclosed environment 131 and/or to determine the location of an occupant within the enclosed environment 131. For example, one or more cameras 111 may capture images of the enclosed environment 131, and the processor 190 may use the images to determine whether each seat within the enclosed environment 131 is occupied by an occupant. In various implementations, the processor 190 may use the images to make a binary determination of whether a seat is occupied or unoccupied, or may determine whether a seat is occupied by a particular occupant. In one or more implementations, the occupant can be actively identified by information provided by the occupant upon entry into the enclosed environment 131 (e.g., by scanning an identity card or a mobile device acting as an identity card with a sensor 113, or by facial recognition or other identity verification using the cameras 111 and/or the sensors 113), or passively (e.g., by determining that a seat is occupied and that that seat has been previously reserved for a particular occupant during a particular time period, such as by identifying an occupant of a seat as a ticketholder for that seat).

Communications circuitry, such as RF circuitry 103, optionally includes circuitry for communicating with electronic devices, networks, such as the Internet, intranets, and/or a wireless network, such as cellular networks and wireless local area networks (LANs). RF circuitry 103 optionally includes circuitry for communicating using near-field communication and/or short-range communication, such as Bluetooth®. RF circuitry 103 may be operated (e.g., by processor 190) to communicate with a portable electronic device in the enclosed environment 131.

In one or more implementations, one or more cameras 111 may capture images of the enclosed environment 131 and/or sensors 113 may obtain sensor information describing aspects of the enclosed environment (e.g., a depth map of the enclosed environment), and the processor 190 may use the images and/or sensor information to determine the location, within the enclosed environment 131, of one or more objects and/or occupants within the enclosed environment.

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118. In one or more implementations, the apparatus 100 may include multiple displays, such as multiple displays each facing a respective occupant location within the enclosure 108, for outputting video content to an occupant at that respective occupant location.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal-oxide-semiconductor (CMOS) sensors operable to obtain images within the enclosed environment 131 and/or of an environment external to the enclosure 108. Camera 111 may also optionally include one or more infrared (IR) sensor(s), such as a passive IR sensor or an active IR sensor, for detecting infrared light from within the enclosed environment 131 and/or of an environment external to the enclosure 108. For example, an active IR sensor includes an IR emitter, for emitting infrared light. Camera 111 also optionally includes one or more event camera(s) configured to capture movement of objects such as portable electronic devices and/or occupants within the enclosed environment 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed environment 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. Sensors 113 may also, or alternatively, include one or more scanners (e.g., a ticket scanner, a fingerprint scanner or a facial scanner), one or more depth sensors, one or more motion sensors, one or more temperature or heat sensors, or the like. In some examples, one or more microphones such as microphone 119 may be provided to detect sound from an occupant within the enclosed environment 131 and/or from one or more audio sources external to the enclosure 108. In some examples, microphone 119 includes an array of microphones that optionally operate in tandem, such as to identify ambient noise or to locate the source of sound in space.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, speaker 118 may be implemented as an omnidirectional speaker, a directional speaker (e.g., a directional speaker having sound-suppression acoustic ducts, a dual-directional speaker, or an isobaric cross-firing speaker), or a speaker of a beamforming speaker array, or any other speaker having the capability (e.g., alone or in cooperation with one or more other speakers) to direct and/or beam sound to one or more desired locations.

For example, in one or more implementations, the speaker 118 may be implemented with an acoustic port through which sound (e.g., generated by a moving diaphragm or other sound-generating component) is projected, a back volume, and one or more sound-suppression acoustic ducts fluidly coupled to the back volume and configured to output sound from the back volume. Because the sound from the back volume will have a polarity (e.g., a negative polarity) that is opposite to a polarity (e.g., a positive polarity) output from the acoustic port, the sound from the back volume may cancel a portion of the sound from the acoustic port, in one or more directions defined by the arrangement of the one or more sound-suppression acoustic ducts. Each sound-suppressing acoustic duct may include one or more slots that aid in the directivity of the sound projected from that sound-suppressing acoustic duct.

As another example, speaker 118 may be implemented as a dual-directional speaker that includes a sound-generating element mounted between a pair of acoustic ducts. Sound generated by the sound-generating element may project sound into an aperture at the center of a channel housing that can then propagate down each of the acoustic ducts. Each acoustic duct may include one or more slots that aid in the directivity of the sound projected from that acoustic duct.

As another example, speaker 118 may be implemented as an isobaric cross-firing speaker that includes a housing defining a back volume, a first speaker diaphragm having a first surface adjacent the back volume and an opposing second surface facing outward, and a second speaker diaphragm having a first surface adjacent the back volume (e.g., the same back volume, which may be referred to herein as a shared back volume) and an opposing second surface facing outward at an angle different from the angle at which the first speaker diaphragm faces. In this configuration, in operation, the first speaker diaphragm projects sound in a first direction and the second speaker diaphragm projects sound in a second direction different from the first direction. The first speaker diaphragm and the second speaker diaphragm can be operated out of phase so that the sound generated by the second speaker diaphragm cancels at least a portion of the sound generated by the first speaker diaphragm at a location toward which the second speaker diaphragm faces.

As another example, the speaker 118 may be a speaker of a beamforming speaker array. In a beamforming speaker array, multiple speakers of the array can be operated to beam one or more desired sounds toward one or more desired locations within the enclosed environment 131.

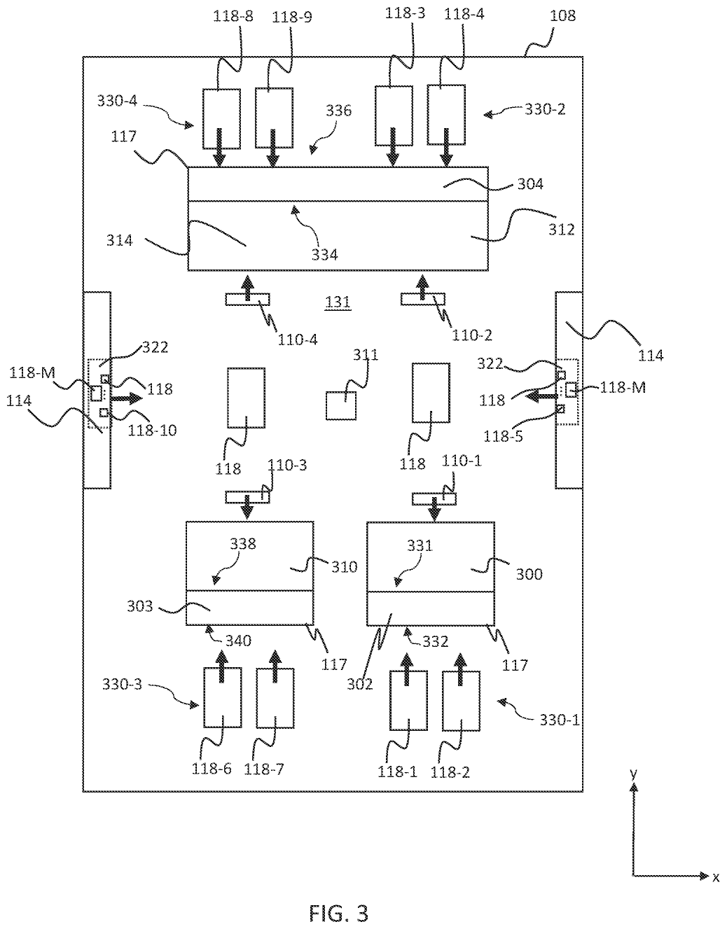

FIG. 3 illustrates a schematic top view of an example implementation of the apparatus 100 in which various speakers 118 (e.g., in one or more of the implementations described herein) are disposed at various locations within the apparatus 100. In the example of FIG. 3, the apparatus 100 includes the enclosure 108 and a seat 300 within the enclosure 108. As shown, the seat 300 may have a seat back 302 with a first side 331 configured to interface with an occupant within the enclosure (e.g., when the occupant is seated on the seat 300 and resting their back against the seat back 302), and an opposing second side 332. As indicated, the seat 300 may be an implementation of the support feature 117 of FIG. 2. In the example of FIG. 3, the seat 300 faces in the positive y direction indicated in the figure (merely for convenience of the present description).

In the example of FIG. 3, the apparatus 100 also includes a seat 310 facing in the same direction (e.g., facing in the positive y direction) as the seat 300 (e.g., and having a seat back 303 with a first side 338 configured to interface with an occupant within the enclosure, such as when the occupant is seated on the seat 310 and resting their back against the seat back 303, and an opposing second side 340). In this example, the apparatus 100 also includes a seat 312 and a seat 314 having a seat back 304 and facing (e.g., in the negative y direction) toward the seat 300 and the seat 310 (e.g., facing in an opposite direction to the direction in which the seat 300 and the seat 310 face) and having a seat back 304 with a first side 334 configured to interface with an occupant within the enclosure, such as when the occupant is seated on the seat 312 or the seat 314 and resting their back against the seat back 304, and having an opposing second side 336.

The orientation of the seats 312 and 314 of FIG. 3 is merely illustrative, and, in one or more other implementations, the seats 312 and/or 314 may face in the same direction as the seats 300 and 310 face (e.g., toward a front of the apparatus) or in another direction. In one or more implementations, the seat 312 and/or the seat 314 may be rotatable between multiple orientations. For example, in one or more implementations, the seat 314 may face in the direction of seat 310 as in FIG. 3 when the apparatus 100 is a vehicle operating in a fully autonomous driving mode, and may rotate to face away from the seat 310 (e.g., toward the front of the vehicle) when the vehicle is in a human-operator mode or in an semiautonomous mode. In one or more other implementations, the seat 312 and/or the seat 314 may be fixedly mounted in the forward facing direction. In one or more implementations, the speakers 118-8 and 118-9 (e.g., and/or one or more other speakers in the enclosure 108) may be operable to create a sound stage for the seat 314 that matches the left-right orientation of the seat 314 in any orientation of the seat 314 (e.g., and that follows the orientation of the seat 314 when the seat 314 is rotated).

In the example of FIG. 3, the apparatus 100 includes speakers 118 at various locations. It is appreciated that one, any sub-combination, or all, of the speakers 118 shown in FIG. 3 may be implemented in the apparatus 100. It is also appreciated that additional speakers 118 may be implemented in the apparatus 100 at one or more other locations, and the locations of the speakers 118 of FIG. 3 are merely illustrative.

In the example of FIG. 3, the apparatus 100 includes a speaker 118 disposed between the seat 300 and the seat 312, and a speaker 118 disposed between the seat 310 and the seat 314. In this example, the speaker 118 disposed between the seat 300 and the seat 312, and the speaker 118 disposed between the seat 310 and the seat 314 may be implemented as a directional speaker (e.g., a directional speaker having one or more sound-suppressing acoustic ducts, a dual-directional speaker having a pair of acoustic ducts, or an isobaric cross-firing speaker, or any other directional speaker), configured to direct audio output toward one or more particular locations within the enclosed environment 131, such as the location of one of the seats within the enclosure 108.

In the example of FIG. 3, the apparatus 100 includes a beamforming speaker array 322 (e.g., including multiple speakers 118 arranged in one or more rows) mounted in an access feature 114 (e.g., a first door on a first side of the enclosure 108), and a beamforming speaker array 322 mounted in another access feature 114 (e.g., a second door on an opposing second side of the enclosure 108). Each of the beamforming speaker arrays 322 can be operated to beam one or more audio outputs (e.g., multiple audio outputs corresponding to multiple respective audio channels) to one or more desired locations within the enclosed environment 131. In one or more implementations, the speaker(s) 118 (e.g., including one or more speakers 118 implemented in the beamforming speaker array(s) 322) may be operated (e.g., by the processor 190) to generate audio output that creates a sound stage that is oriented in synchronization with the orientation of video content displayed on a display of the apparatus 100 or by a portable electronic device that is disposed within and/or operating within the enclosed environment 131 of the apparatus 100. As illustrated in FIG. 3, the beamforming speaker arrays 322 may include speakers of various sizes, such as multiple speakers 118 implemented as tweeters, and one or more lower frequency speakers (e.g., having relatively larger sizes than the size of the tweeters), such as a mid-range speaker 118-M.

In the example of FIG. 3, wide arrows indicate a direction in which a speaker or a display faces (e.g., the direction toward which a sound-generating element of a speaker or a light-generating element of a display is physically directed). In the example of FIG. 3, the apparatus 100 includes a first speaker assembly 330-1 including a first speaker 118-1 and a second speaker 118-2 that face in a first direction (e.g., a direction substantially parallel to the positive y direction) and that are laterally spaced apart in a second direction (e.g., a direction substantially parallel to the x direction) substantially perpendicular to the first direction. In this example, the apparatus 100 also includes a second speaker assembly 330-2 including a third speaker 118-3 and a fourth speaker 118-4 that face in a third direction (e.g., the negative y direction) opposite the first direction and that are laterally spaced apart in a fourth direction (e.g., a direction substantially parallel to the x direction) substantially perpendicular to the third direction such that the third speaker 118-3 substantially faces the first speaker 118-1 and the fourth speaker 118-4 substantially faces the second speaker 118-2.

In this example, the apparatus 100 also includes at least one fifth speaker 118-5 (e.g., a speaker 118 of a beamforming speaker array 322) disposed substantially between the first speaker assembly 330-1 and the second speaker assembly 330-2 and facing in a fifth direction (e.g., the negative x direction) substantially parallel to the second direction and the fourth direction.

In the example of FIG. 3, the apparatus 100 also includes a third speaker assembly 330-3 including a sixth speaker 118-6 and a seventh speaker 118-7 that face in a direction substantially parallel to the first direction (e.g., a direction substantially parallel to the positive y direction) and that are laterally spaced apart in the second direction. In this example, the apparatus 100 also includes a fourth speaker assembly 330-4 including an eighth speaker 118-8 and a ninth speaker 118-9 that face in a direction substantially parallel to the third direction (e.g., the negative y direction) and that are laterally spaced apart in the fourth direction such that the sixth speaker 118-6 substantially faces the eighth speaker 118-8 and the seventh speaker 118-7 substantially faces the ninth speaker 118-9.

In this example, the apparatus 100 also includes at least one tenth speaker 118-10 (e.g., a speaker 118 of a beamforming speaker array 322) disposed substantially between the third speaker assembly 330-3 and the fourth speaker assembly 330-4 and facing in a sixth direction (e.g., the positive x direction) substantially parallel to the second direction and the fourth direction, and opposite the fifth direction.

In the example of FIG. 3, the apparatus 100 also includes a first display 110-1 facing (e.g., in the negative y direction) the seat 300, a second display 110-2 facing (e.g., in the positive y direction) the seat 312, a third display 110-3 facing (e.g., in the negative y direction) the seat 310, and a fourth display 110-4 facing (e.g., in the positive y direction) the seat 314. In this example, the apparatus 100 includes a first display substantially facing the first speaker assembly 330-1, and a second display substantially facing the second speaker assembly 330-2.

In the example of FIG. 3, the apparatus includes four seats, four speaker assemblies, and four displays. However, this is merely illustrative, and, in other implementations, fewer than four, or more than four seats, speaker assemblies, and/or displays may be included within the enclosure 108. In the example of FIG. 3, the displays 110 are displays of the apparatus 100 (e.g., permanently mounted to an apparatus structure within the enclosure 108). However, in other implementations, the displays may be portable displays that may be carried into and/or out of the enclosure and may be permanently associated with the apparatus 100, or may be associated with a user and temporarily paired with the apparatus 100 while the user is an occupant of the apparatus.

In the arrangement shown in FIG. 3, the first speaker 118-1 and the second speaker 118-2 of the first speaker assembly 330-1 are disposed behind the seat 300 (e.g., nearer the second side 332 of the seat back 302 than the first side 331 of the seat back 302), the third speaker 118-3 and the fourth speaker 118-4 of the second speaker assembly 330-2 are disposed behind the seat 312 (e.g., nearer the second side 336 of the seat back 304 than the first side 334 of the seat back 304), the sixth speaker 118-6 and the seventh speaker 118-7 of the third speaker assembly 330-3 are disposed behind the seat 310 (e.g., nearer the second side 340 of the seat back 303 than the first side 338 of the seat back 303), and the eighth speaker 118-8 and the ninth speaker 118-9 of the fourth speaker assembly 330-4 are disposed behind the seat 314 (e.g., nearer the second side 336 of the seat back 304 than the first side 334 of the seat back 304). In one or more implementations, the first speaker 118-1 and the second speaker 118-2 of the first speaker assembly 330-1 may be disposed within or mounted to the seat back 302 (e.g., mounted in a headrest component of the seat back 302), the third speaker 118-3 and the fourth speaker 118-4 of the second speaker assembly 330-2 may be disposed within or mounted to the seat back 304 (e.g., mounted in a headrest component of a portion of the seat back 304 for the seat 312), the sixth speaker 118-6 and the seventh speaker 118-7 of the third speaker assembly 330-3 may be disposed within or mounted to seat back 303 (e.g., mounted in a headrest component of a portion of the seat back 303), and/or the eighth speaker 118-8 and the ninth speaker 118-9 of the fourth speaker assembly 330-4 may be disposed within or mounted to the seat back 303 (e.g., mounted in a headrest component of a portion of the seat back 304 for seat 314).

In the example of FIG. 3, when an occupant is seated in, for example, the seat 300 and viewing the first display 110-1, video content displayed on the first display 110-1 will have a left-to-right orientation that is substantially parallel to the positive x direction indicated in FIG. 3. In this example, when an occupant is seated in, for example, the seat 312 and viewing the second display 110-2, video content displayed on the second display 110-2 will have a left-to-right orientation that is substantially parallel to the negative x direction indicated in FIG. 3, which may be substantially opposite to the left-to-right orientation of the video content on the first display 110-1 (e.g., even if the video content displayed by the first display 110-1 is the same as the video content displayed on the second display 110-2, such as if first display 110-1 and the second display 110-2 are playing the same movie). Similarly, an occupant is seated in, for example, the seat 310 and viewing the third display 110-3, video content displayed on the third display 110-3 will have a left-to-right orientation that is substantially parallel to the positive x direction indicated in FIG. 3. In this example, when an occupant is seated in, for example, the seat 314 and viewing the fourth display 110-4, video content displayed on the fourth display 110-4 will have a left-to-right orientation that is substantially parallel to the negative x direction indicated in FIG. 3, which may be substantially opposite to the left-to-right orientation of the video content on the third display 110-3 (e.g., even if the video content displayed by the third display 110-3 is the same as the video content displayed on the fourth display 110-4, such as if the third display 110-3 and the fourth display 110-4 are playing the same episode of a series).

Accordingly, if the apparatus 100 were to operate the speakers 118 of the apparatus 100 with a preferred left-to-right stereo orientation for the occupant in the seat 300 or the occupant in the seat 312, the left-to-right stereo orientation of the audio content for one of the two occupants would be inconsistent with the left-to-right orientation of the video content being displayed on the display facing that occupant and/or inconsistent with the left-to-right orientation of the occupant's head. Moreover, even if stereo audio content is not associated with video content on a display, if the apparatus 100 were to operate the speakers 118 of the apparatus 100 with a preferred left-to-right stereo orientation for the occupant in the seat 300 or the occupant in the seat 312, the left-to-right stereo orientation of the audio content for one of the two occupants would be inconsistent with the left-to-right orientation of the occupant's head.

In one or more implementations, the subject technology provides for various sound stage orientations, such as a sound stage reversal, within the enclosed environment 131. The sound stage orientation control described herein can provide a left-to-right stereo orientation of audio content for one, two, or more than two occupants that is consistent with the left-to-right orientation of the occupant (e.g., the occupant's head) and/or with left-to-right stereo orientation of video content being displayed on a display facing that occupant, even if multiple occupants are facing in multiple different directions within the enclosed environment 131.

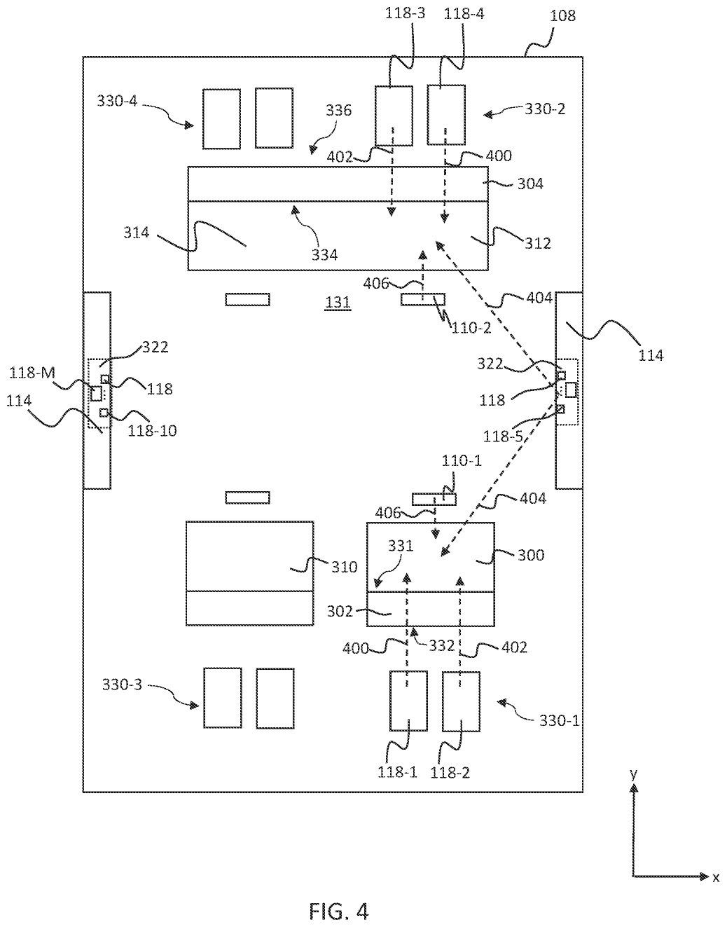

For example, FIG. 4 illustrates a top view of the apparatus 100 in which the first speaker 118-1 and the fourth speaker 118-4 are configured to output left audio content 400, the second speaker 118-2 and the third speaker 118-3 are configured to output right audio content 402, and at least the fifth speaker 118-5 is configured to combine and output the left and right audio content in a combined audio output 404. In this example, the beamforming speaker array 322 including the fifth speaker 118-5 is operated to beam the combined audio output 404 toward both the seat 300 and the seat 312. In another implementation, the fifth speaker 118-5 may be an omnidirectional speaker that outputs the combined audio output 404 in all directions in a hemisphere in front of the speaker, including toward the seat 300 and the seat 312. In one or more implementations, the beamforming speaker array 322 and/or one or more speakers thereof or one or more individual speakers 118 may also beam otherwise project the combined audio output 404 toward both the seat 300 and the seat 312.

In one or more implementations, outputting the combined audio output 404 from a location in front of an occupant (e.g., from the location of the access features substantially in front of an occupant in the seat 300 or the seat 312), while outputting a left portion (e.g., left audio content 400) of that combined audio output from a left speaker (e.g., first speaker 118-1 or fourth speaker 118-4) nearby the occupant's left ear and a right portion (e.g., right audio content 402) of that combined audio output from a right speaker (e.g., second speaker 118-2 or third speaker 118-3) nearby the occupant's right ear, an occupant in either the seat 300 or the seat 312 may be caused to perceive left to right moving audio content moving from left to right in front of the occupant (e.g., in spatial synchronization respectively with left-to-right motion of video content in a video output 406 from the display 110-1 and with substantially opposite left-to-right motion of the same video content in a video output 406 from the display 110-2)), even when the left speaker and the right speaker are disposed behind the occupant's head (e.g., behind the seat in which the occupant is seated, or in the headrest of the seat in which the occupant is seated). For example, the output of the combined audio output 404 from a speaker that is substantially in front of the occupant can psycho-acoustically pull the occupant's perception of the sound to a location in front of the occupant. In this way, a relative reversal of the sound stages for opposite-facing occupants can be created.

In one or more implementations, to aid in the sound stage reversal effect for an occupant in the seat 300, the fifth speaker 118-5 may output the combined audio output 404 before the first speaker assembly 330-1 and the second speaker assembly 330-2 separately output the left audio content 400 and the right audio content 402. For example, the apparatus 100 (e.g., the processor 190) may delay the output of the left audio content 400 and the right audio content 402 by the first speaker assembly 330-1 and the second speaker assembly 330-2, relative to the output of the combined audio output 404 by the fifth speaker 118-5 (e.g., and/or other speakers of the beamforming speaker array 322). For example, the apparatus 100 may delay the output of the left audio content 400 and the right audio content 402 by the first speaker assembly 330-1 and the second speaker assembly 330-2, relative to the output of the combined audio output 404 by the fifth speaker 118-5 by a delay time that is based on a difference between the distance from the fifth speaker 118-5 and the seat 300 and the distance from the first speaker assembly 330-1 and the seat 300. As examples, the delay time may be up to five milliseconds, between ten milliseconds, or less than 100 milliseconds. In this way, the apparatus may cause the combined audio output 404 to arrive at an occupant the seat 300 at the same time that the left audio content 400 and the right audio content 402 arrive at the seat 300. In one or more implementations, the first speaker 118-1 and the third speaker 118-3 may output the left audio content 400 at the same time, and the second speaker 118-2 and the fourth speaker 118-4 may output the right audio content 402 at the same time (e.g., the same time as the output of the left audio content 400 by the first speaker 118-1 and the third speaker 118-3).

In the examples of FIGS. 3-5, sound stage reversal is described in connection with occupants facing in opposite directions. However, the subject technology can also be applied to rotate the relative orientations of multiple sound stages in an enclosed environment at angles other than 180 degrees (e.g., sound stage rotations other than sound stage reversals can be provided) and/or at variable orientation angles (e.g., for rotatable seat configurations).

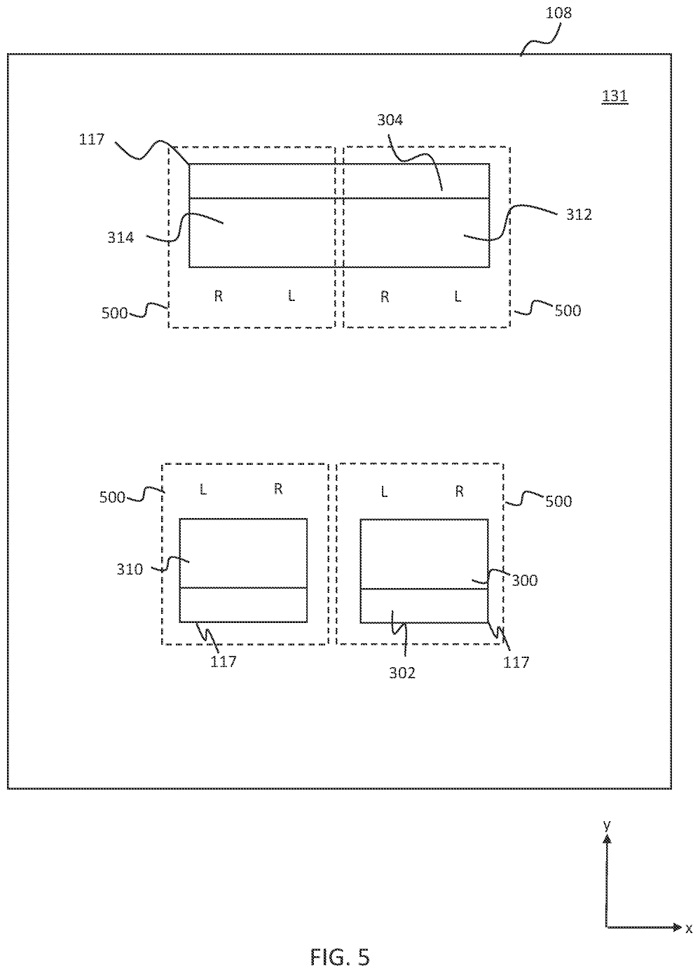

FIG. 5 illustrates a top view of the apparatus 100 in which each of the seats within the enclosure is provided with a sound stage 500 that is oriented based on the orientation of that seat, by appropriate operation of the various speakers 118 of the apparatus, as described herein. As shown, the seat 300 and the seat 310 each have a sound stage 500 oriented with a left-to-right orientation that is substantially parallel to the x direction in the figure, and the seat 312 and the seat 314 each have a sound stage 500 that is oriented, opposite to the sound stages of the seat 300 and the seat 310) with a left-to-right orientation that is substantially parallel to the negative x direction of the figure. However, it is also appreciated that the arrangements of the sound stages 500 of FIG. 5 are merely illustrative, and various sound stages 500 may be created within the enclosure in substantially any orientation that corresponds to the orientation of a seat and/or an occupant.

For example, in one or more implementations, the apparatus 100 may include an enclosure (e.g., enclosure 108), a first seat (e.g., seat 300) within the enclosure and having a first orientation, a second seat (e.g., seat 312) within the enclosure and having a second orientation, different from the first orientation, a first speaker assembly (e.g., speaker assembly 330-1) associated with the first seat (e.g., behind the first seat and facing toward the seat in the same direction as the seat as in the examples of FIGS. 3 and 4, in front of the seat and facing toward the seat in the opposite direction of the seat, within a headrest of the seat, or above or below the seat and facing the seat), a second speaker assembly associated with the second seat (e.g., behind the first seat and facing toward the seat in the same direction as the seat as in the examples of FIGS. 3 and 4, in front of the seat and facing toward the seat in the opposite direction of the seat, within a headrest of the seat, or above or below the seat and facing the seat), and a computing component (e.g., processor 190).

The computing component may operate the first speaker assembly to generate first stereo audio output having the first orientation, and operate, concurrently with the first stereo audio output of the first speaker assembly, the second speaker assembly to generate second stereo audio output (e.g., the first stereo audio output and the second stereo audio output including the same audio content) having the second orientation. For example, the first orientation and the second orientation may be substantially opposite to each other, or may be oriented in any two other different orientations or in the same orientation. In one or more implementations, the apparatus 100 may include at least one additional speaker, and the computing component may operate the at least one additional speaker, concurrently with operating the first speaker assembly and the second speaker assembly, to generate a portion of both the first stereo audio output and the second stereo audio output. In the examples of FIGS. 3-5, the seats 300 and 312 face each other, and the seats 310 and 314 face each other, and the speaker assemblies 330-1, 330-2, 330-3, and 330-4 face in the same directions as the corresponding seat for which that speaker assembly generates a sound stage. In other implementations, the seats 300, 310, 312, and 314 (e.g., and more or fewer seats) may be arranged in other relative orientations, such as in a circle facing a central interior point within the enclosure 108, in a circle facing outward from a central interior point, or in any other arrangement, and the speaker assembly that generates a sound stage for each seat may also be oriented in the same or opposite direction with the corresponding seat to generate a sound stage oriented for the orientation of that seat (e.g., even in implementations in which all of the seats face in the same direction and/or in which seats are rotatable among various different orientations). In one or more implementations, one or more speakers of a speaker assembly for generating a sound stage for a rotatable seat in an enclosure may rotate with the rotatable seat, or a computing component can alter the relative outputs of the speakers of the speaker assembly to rotate the sound stage for the rotatable seat without physically rotating the speakers and/or speaker assembly.

In one or more implementations, the apparatus 100 may include an enclosure 108, and a computing component (e.g., processor 190) configured to operate the first speaker 118-1 and the second speaker 118-2 to respectively output the left audio content 400 and the right audio content 402, and operate the at least one fifth speaker 118-5 to output the combined audio output 404 to generate a first sound stage 500 having a first orientation within the enclosure 108, and operate the third speaker 118-3 and the fourth speaker 118-4 to respectively output the right audio content 402 and the left audio content 400, and operate the at least one fifth speaker 118-5 to output the combined audio output 404 to generate a second sound stage 500 having a second orientation, different from the first orientation (e.g., opposite or otherwise different), within the enclosure 108. As discussed herein, in one or more implementations, the apparatus 100 may include a first seat (e.g., seat 300) within the enclosure 108 and a second seat (e.g., seat 312) within the enclosure. In one or more implementations, the first speaker assembly 330-1 may be disposed behind, within, in front of, above, or below the first seat, and the second speaker assembly may be disposed behind, within, in front of, above, or below the second seat. For example, in one or more implementations, the first seat faces in the first direction (e.g., the positive y direction), and the second seat faces in the third direction (e.g., the negative y direction).

In one or more implementations, the apparatus 100 may also include a third speaker assembly 330-3 including a sixth speaker 118-6 and a seventh speaker 118-7 that face in the first direction (e.g., the positive y direction) and that are laterally spaced apart from each other and from the first speaker assembly 330-1 in the second direction (e.g., the positive or negative x direction) substantially perpendicular to the first direction, a fourth speaker assembly 330-4 including an eighth speaker 118-8 and a ninth speaker 118-9 that face in the third direction (e.g., the negative y direction) opposite the first direction and that are laterally spaced apart in the fourth direction substantially perpendicular to the third direction, such that the sixth speaker 118-6 substantially faces the eighth speaker 118-8 and the seventh speaker 118-7 substantially faces the ninth speaker 118-9, and at least a tenth speaker 118-10 disposed substantially between the third speaker assembly 330-3 and the fourth speaker assembly 330-4 and facing in a sixth direction (e.g., the positive x direction) substantially opposite the fifth direction and substantially parallel to the second direction and the fourth direction. The sixth speaker 118-6 and the ninth speaker 118-9 may be configured to output the left audio content, the seventh speaker 118-7 and the eighth speaker 118-8 may be configured to output the right audio content, and at least the tenth speaker 118-10 may be configured to output the combined audio output including the left audio content and the right audio content.

In one or more implementations, the apparatus 100 may also include a third seat (e.g., seat 310) within the enclosure 108, and a fourth seat (e.g., seat 314) within the enclosure 108. In one or more implementations, the third speaker assembly 330-3 may be disposed behind, within, in front of, above, or below the third seat, and the fourth speaker assembly may be disposed behind, within, in front of, above, or below the fourth seat. In one or more implementations, the computing component may operate the at least the fifth speaker 118-5 (e.g., and/or at least the tenth speaker 118-10) to output the combined audio output before (e.g., 1-100 milliseconds before) operating the first speaker and the fourth speaker to output the left audio content. The computing component may operate the first speaker 118-1 and the fourth speaker 118-4 to output the left audio content at the same time as operating the second speaker 118-2 and the third speaker 118-3 to output the right audio content.

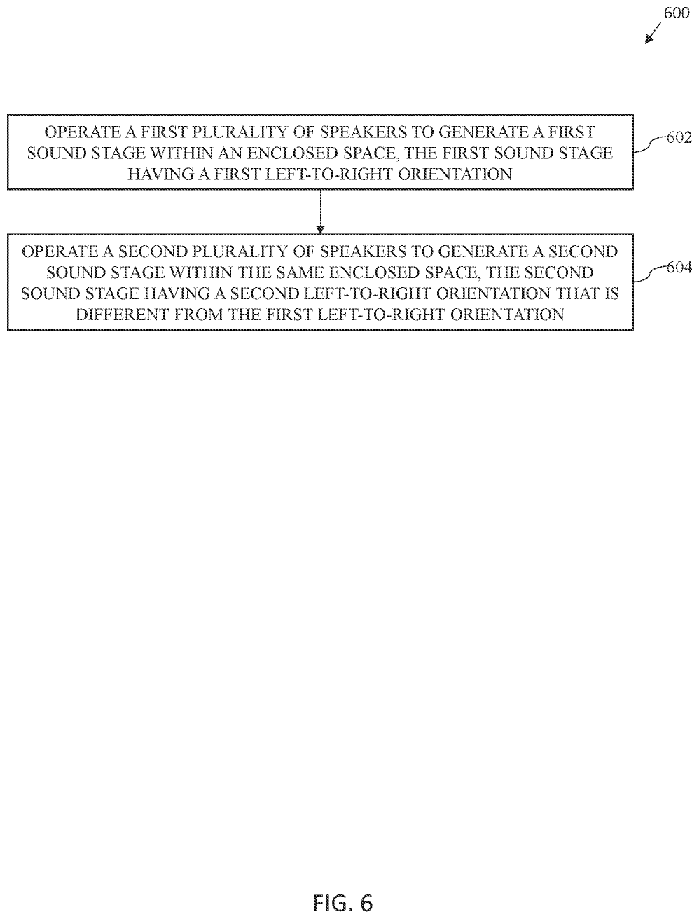

FIG. 6 illustrates a flow diagram of an example process 600 for providing sound stage orientation (e.g., sound stage reversal) in an enclosed environment, in accordance with implementations of the subject technology. For explanatory purposes, the process 600 is primarily described herein with reference to the apparatus 100 of FIGS. 1 and 2. However, the process 600 is not limited to the apparatus 100 of FIGS. 1 and 2, and one or more blocks (or operations) of the process 600 may be performed by one or more other components of other suitable devices or systems. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, a first plurality of speakers (e.g., including the first speaker 118-1 and the second speaker 118-2 of first speaker assembly 330-1, or the sixth speaker 118-6 and the seventh speaker 118-7 of the third speaker assembly 330-3) may be operated to generate a first sound stage (e.g., sound stage 500) within an enclosed space (e.g., the enclosed environment 131), the first sound stage having a first left-to-right orientation. For example, the enclosed space may be defined by an enclosure, such as the enclosure 108 described herein.

At block 604, a second plurality of speakers (e.g., including the third speaker 118-3 and the fourth speaker 118-4 of second speaker assembly 330-2, or the eighth speaker 118-8 and the ninth speaker 118-9 of the fourth speaker assembly 330-4) may be operated (e.g., concurrently with the operation of the first plurality of speakers and/or at a different time from the operation of the first plurality of speakers) to generate a second sound stage (e.g., a sound stage 500) within the same enclosed space, the second sound stage having a second left-to-right orientation that is different from the first left-to-right orientation.

In one or more implementations, the first left-to-right orientation is opposite the second left-to-right orientation. In one or more implementations, the first left-to-right orientation is oriented at a non-zero angle other than one-hundred-eighty degrees relative to the second left-to-right orientation. In one or more implementations, the first plurality of speakers and the second plurality of speakers include at least one common speaker (e.g., a speaker 118 of a beam forming speaker array 322, a central speaker 311, or another speaker 118 within the enclosure 108). For example, the at least one common speaker may include a speaker of a beamforming speaker array (e.g., a beamforming speaker array 322, which may be mounted in an access feature such as an access feature 114). In one or more implementations, the at least one common speaker is disposed substantially between the first sound stage and the second sound stage (e.g., as discussed above in connection with FIGS. 3 and 4). In one or more implementations, the first sound stage is associated with a first seat (e.g., seat 300 or seat 310) having the first left-to-right orientation, and the second sound stage is associated with a second seat (e.g., seat 312 or seat 314) having the second left-to-right orientation.

In one or more implementations, the first plurality of speakers includes a first speaker (e.g., first speaker 118-1) and a second speaker (e.g., second speaker 118-2) disposed behind or within a headrest of the first seat. In one or more implementations, the second plurality of speakers includes a third speaker (e.g., third speaker 118-3) and a fourth speaker (e.g., fourth speaker 118-4) disposed behind or within a headrest of the second seat. In one or more implementations, operating the first plurality of speakers to generate the first sound stage within the enclosed space includes outputting left audio content with the first speaker and outputting right audio content with the second speaker. In one or more implementations, operating the second plurality of speakers to generate the second sound stage within the same enclosed space includes outputting the left audio content with the fourth speaker and outputting the right audio content with the third speaker.

In one or more implementations, the process 600 may also include operating the at least one common speaker to output combined audio content including the left audio content and the right audio content, delayed (e.g., in time by one millisecond, three milliseconds, five milliseconds, or less than 10 milliseconds) relative to the output of the left audio content by the first speaker and the fourth speaker and the right audio content by the second speaker and the third speaker. In one or more implementations, the process 600 may also include operating a first display (e.g., first display 110-1 or third display 110-3) within the enclosed space to display video content in the first left-to-right orientation, and operating a second display (e.g., second display 110-2 or fourth display 110-4) within the enclosed space to display the video content oriented in the second left-to-right orientation. In various implementations, the first display and/or the second display may be integral components of an apparatus including the enclosure, or may be portable electronic devices that one or more occupants have carried into the enclosure.

Various processes defined herein consider the option of obtaining and utilizing a user's personal information. For example, such personal information may be utilized in order to provide sound-stage reversal in an enclosed environment. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

In accordance with aspects of the subject disclosure, an apparatus is provided that includes a first speaker assembly including a first speaker and a second speaker that face in a first direction and that are laterally spaced apart in a second direction substantially perpendicular to the first direction; a second speaker assembly including a third speaker and a fourth speaker that face in a third direction opposite the first direction and that are laterally spaced apart in a fourth direction substantially perpendicular to the third direction, such that the third speaker substantially faces the first speaker and the fourth speaker substantially faces the second speaker; and at least one fifth speaker disposed substantially between the first speaker assembly and the second speaker assembly and facing in a fifth direction substantially parallel to the second direction and the fourth direction, wherein the first speaker and the fourth speaker are configured to output left audio content, the second speaker and the third speaker are configured to output right audio content, and the at least one fifth speaker is configured to output a combined audio output including the left audio content and the right audio content.

In accordance with aspects of the subject disclosure, a method is provided that includes operating a first plurality of speakers to generate a first sound stage within an enclosed space, the first sound stage having a first left-to-right orientation; and operating a second plurality of speakers to generate a second sound stage within the same enclosed space, the second sound stage having a second left-to-right orientation that is different from the first left-to-right orientation.

In accordance with aspects of the subject disclosure, an apparatus is provided that includes an enclosure; a first seat within the enclosure and having a first orientation; a second seat within the enclosure and having a second orientation, different from the first orientation; a first speaker assembly associated with the first seat; a second speaker assembly associated with the second seat; and a computing component configured to: operate the first speaker assembly to generate first stereo audio output having the first orientation; and operate, concurrently with the first stereo audio output of the first speaker assembly, the second speaker assembly to generate second stereo audio output having the second orientation.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. An apparatus, comprising:
a first speaker assembly including a first speaker and a second speaker that face in a first direction and that are laterally spaced apart in a second direction substantially perpendicular to the first direction;
a second speaker assembly including a third speaker and a fourth speaker that face in a third direction opposite the first direction and that are laterally spaced apart in a fourth direction substantially perpendicular to the third direction, such that the third speaker substantially faces the first speaker and the fourth speaker substantially faces the second speaker; and
at least one fifth speaker disposed substantially between the first speaker assembly and the second speaker assembly and facing in a fifth direction substantially parallel to the second direction and the fourth direction,
wherein the first speaker and the fourth speaker are configured to output left audio content, the second speaker and the third speaker are configured to output right audio content, and the at least one fifth speaker is configured to output a combined audio output including the left audio content and the right audio content.

2. The apparatus of claim 1, further comprising:
an enclosure; and
a computing component configured to:
operate the first speaker and the second speaker to respectively output the left audio content and the right audio content, and operate the at least one fifth speaker to output the combined audio output to generate a first sound stage having a first orientation within the enclosure; and
operate the third speaker and the fourth speaker to respectively output the right audio content and the left audio content, and operate the at least one fifth speaker to output the combined audio output to generate and a second sound stage having a second orientation, different from the first orientation, within the enclosure.

3. The apparatus of claim 2, further comprising:
a first seat within the enclosure; and
a second seat within the enclosure, wherein:
the first speaker assembly is disposed behind the first seat, and
the second speaker assembly is disposed behind the second seat.

4. The apparatus of claim 3, wherein the first seat faces in the first direction, and wherein the second seat faces in the third direction.

5. The apparatus of claim 4, wherein the at least one fifth speaker comprises a beamforming array of speakers.

6. The apparatus of claim 4, further comprising:
a third speaker assembly including a sixth speaker and a seventh speaker that face in the first direction and that are laterally spaced apart from each other and from the first speaker assembly in the second direction substantially perpendicular to the first direction;
a fourth speaker assembly including an eighth speaker and a ninth speaker that face in the third direction opposite the first direction and that are laterally spaced apart in the fourth direction substantially perpendicular to the third direction, such that the sixth speaker substantially faces the eighth speaker and the seventh speaker substantially faces the ninth speaker; and
at least one tenth speaker disposed substantially between the third speaker assembly and the fourth speaker assembly and facing in a sixth direction substantially opposite the fifth direction and substantially parallel to the second direction and the fourth direction,
wherein the sixth speaker and the ninth speaker are configured to output the left audio content, the seventh speaker and the eighth speaker are configured to output the right audio content, and the at least one tenth speaker is configured to output the combined audio output including the left audio content and the right audio content.

7. The apparatus of claim 6, further comprising:
a third seat within the enclosure; and
a fourth seat within the enclosure, wherein:
the third speaker assembly is disposed behind the third seat, and
the fourth speaker assembly is disposed behind the fourth seat.

8. The apparatus of claim 2, wherein the computing component is configured to operate the at least one fifth speaker to output the combined audio output before operating the first speaker and the fourth speaker to output the left audio content.

9. The apparatus of claim 8, wherein the computing component is configured to operate the first speaker and the fourth speaker to output the left audio content at the same time as operating the second speaker and the third speaker to output the right audio content.

10. The apparatus of claim 1, further comprising:
a first display substantially facing the first speaker assembly; and
a second display substantially facing the second speaker assembly.

11. A method, comprising:
operating a first plurality of speakers to generate a first sound stage within an enclosed space, the first sound stage having a first left-to-right orientation; and
operating a second plurality of speakers to generate a second sound stage within the same enclosed space, the second sound stage having a second left-to-right orientation that is different from the first left-to-right orientation.

12. The method of claim 11, wherein the first left-to-right orientation is substantially opposite the second left-to-right orientation.

13. The method of claim 12, wherein the first plurality of speakers and the second plurality of speakers include at least one common speaker.

14. The method of claim 13, wherein the at least one common speaker comprises a speaker of a beamforming speaker array.

15. The method of claim 14, wherein the at least one common speaker is disposed substantially between the first sound stage and the second sound stage.

16. The method of claim 15, wherein the first sound stage is associated with a first seat having the first left-to-right orientation, and the second sound stage is associated with a second seat having the second left-to-right orientation.

17. The method of claim 16, wherein:
the first plurality of speakers comprises a first speaker and a second speaker disposed in a headrest of the first seat,
the second plurality of speakers comprises a third speaker and a fourth speaker disposed in a headrest of the second seat,
operating the first plurality of speakers to generate the first sound stage within the enclosed space comprises outputting left audio content with the first speaker and outputting right audio content with the second speaker, and
operating the second plurality of speakers to generate the second sound stage within the same enclosed space comprises outputting the left audio content with the fourth speaker and outputting the right audio content with the third speaker.

18. The method of claim 17, further comprising operating the at least one common speaker to output combined audio content including the left audio content and the right audio content, delayed relative to the output of the left audio content by the first speaker and the fourth speaker and the right audio content by the second speaker and the third speaker.

19. The method of claim 18, further comprising:
operating a first display within the enclosed space to display video content in the first left-to-right orientation; and
operating a second display within the enclosed space to display the video content oriented in the second left-to-right orientation.

20. An apparatus, comprising:
an enclosure;
a first seat within the enclosure and having a first orientation;
a second seat within the enclosure and having a second orientation, different from the first orientation;
a first speaker assembly associated with the first seat;
a second speaker assembly associated with the second seat; and
a computing component configured to:
operate the first speaker assembly to generate first stereo audio output having the first orientation; and
operate, concurrently with the first stereo audio output of the first speaker assembly, the second speaker assembly to generate second stereo audio output having the second orientation.

21. The apparatus of claim 20, further comprising at least one additional speaker, wherein the computing component is configured to operate the at least one additional speaker, concurrently with operating the first speaker assembly and the second speaker assembly, to generate a portion of both the first stereo audio output and the second stereo audio output.

22. The apparatus of claim 20, wherein first stereo audio output and the second stereo audio output include the same audio content.
